(19) United States
(12) Patent Application Publication
(10) Pub. No.: US 2018/0126861 A1
(43) Pub. Date: May 10, 2018

(54) MODULAR VEHICLE SYSTEM WITH AN INCREASED LEVEL OF OPERATIONAL RELIABILITY

(71) Applicant: EnergyBus e.V., Tanna (DE)

(72) Inventors: Johannes Dörndorfer, Schwäbisch Gmünd (DE); Hannes Neupert, Tanna (DE)

(21) Appl. No.: 15/535,005

(22) PCT Filed: Dec. 12, 2015
(86) PCT No.: PCT/EP2015/079511

§ 371 Date: Oct. 4, 2017

(30) Foreign Application Priority Data
Dec. 12, 2014 (EP) 14197824.7

(51) Int. Cl. B60L 11/18

(52) U.S. Cl. CPC B60L 11/1846; B60L 11/1818; B60L 11/182; B60L 11/1844; B60L 2270/36; B60L 2200/12; B60L 2230/12; B60L 2230/14; B60L 2230/16; B60L 11/1842

(57) ABSTRACT

The invention relates to a modular vehicle system comprising an electric vehicle (2) and a module (16) which can be connected to the electric vehicle (2) by means of a plug connection, wherein the electric vehicle (2) at least has an on-board power supply system (3) for supplying power to an electric drive unit (6) of the electric vehicle (2), a control device (9) for communicating with the module (16), and an interface (15), which is connected to the on-board power supply system (3) and the control device (9), for connection to the module (16), which interface (15) forms a first element of the plug connection, wherein the module (16) at least has an electrical arrangement, a module controller (23) for communicating with the control device (9) of the electric vehicle (2), and a connection element (17) which is connected to the electrical arrangement and the module controller (23) and which forms a second element of the plug connection, wherein the interface (15) of the electric vehicle (2) is connected in a detachable manner to the connection element (17) of the module (16) in order to connect the electrical arrangement of the module (16) to the on-board power supply system (3) of the electric vehicle (2), and wherein the interface (15) has a first NFC device (43) and the connection element (17) has a second NFC device (104), which NFC devices are designed for near-field communication with one another, in order to connect the control device (9) of the electric vehicle (2) to the module controller (23). The invention further relates to an electric vehicle and to a module for a modular system of this kind, and also to a method for connecting said electric vehicle and module.

The invention relates to a modular vehicle system, an electric vehicle and a module for connection to an electric vehicle.

For some time now, electrically powered vehicles are becoming more and more important in view of increasing energy costs and the demand for reduced emissions of traffic. Particularly in the area of light electric vehicles, where for instance electric bicycles, pedelecs and scooters can be found, but also wheel chairs and quad bikes, a considerable number of vehicle types are commercially available by now.

All vehicles of this type comprise an electric motor that is applied as a sole or additional drive and that is supplied with electric energy by one or more batteries. It is thus necessary to design the electric system of electric vehicles in a way providing a safe and failure-free power supply of the electric motor.

The entire or a main part of the drive power of such vehicles has to be provided by the electric system of the vehicles. Current and/or operating voltage are therefore regularly higher than at known power driven vehicles. Therefore, there is a relatively high risk of damage in case of an intervention into the electric system, in particular also into the drive system of the vehicle, for example if a non-compatible battery is installed or if an inappropriate charging device is connected with the vehicle. Contrary to regular vehicles, an intervention into the electric system of the vehicle by untrained staff cannot completely be avoided with electric vehicles. Due to the limited battery capacity and the operating distance restricted thereby, it is for example necessary that a user may easily connect a charging device with the vehicle or exchange the battery. An electric vehicle which provides an easy and safe exchange of electric modules, in particular by a user of the vehicle, is known form WO2011/135036 A2.

An accidental disconnecting or connecting of individual components, such as for instance a charging device or a battery, can cause malfunctioning or in the worst case also damages to the electric system of the electric vehicle. Especially in public areas, for instance at public stationary charging columns or, in case of rental offers, at self-service stations open to the public, there is no control if a correct connection takes place between the charging column or station and the vehicle. Besides, the known connection systems do not guarantee safe protection from third party interferences with the connection between charging column and battery. A modular vehicle system, wherein the connection with a module may take place by means of an interlocking system in an especially easy, safe and protected against intervention by unauthorized persons is known from WO2012/107448 A1.

In both of the aforementioned publications there is a communication between the electric vehicle and the module, inter alia to ensure their compatibility. In the case of a charging module in particular electric operating parameters may be checked during compatibility check, to ensure a battery arranged on the side of the electric vehicle can safely be charged by the charging module. For this aim, in one embodiment a control device of the electric vehicle is connected with the module control of the module via a separable bus system.

The safety of contact may be problematic at this connection, in particular if the aforementioned components are exposed to weather. If a communication is not reliably possible, the functionality may be essentially restricted. In the aforementioned case of a charging module a charging of the battery of the electric vehicle is then not possible.

It is hence the object to provide a modular vehicle system which avoids the aforementioned drawbacks of the prior art and which in particular provides a reliable communication between vehicle and module.

The object is solved by a modular vehicle system according to claim 1 comprising an electric vehicle and a module connectable with the electric vehicle by a plug connection, an electric vehicle according to claim 13, a module according to claim 14, and a method according to claim 15. Preferred embodiments of the invention are described in the dependent claims.

A main aspect of the invention is the use of near-field communication and, respectively near-area communication, in the following designated as “NFC” (Near Field Communication), in the plug-connection between the electric vehicle and the module, at least to connect a control device of the electric vehicle with a module control of the module for data exchange. In addition to a reliable communication, even in the case of components subjected to weather, the design according to the invention further provides a galvanic separation between the control device and the module control, which avoids damage of the one component in the case of a malfunction of the concerning other component. The use of NFC in a plug-connection, i.e., of a wireless communication without development of a significant far-field, contrary to RFID-technology, further reduces possible reservations with regard to data safety by the limited operational distance of the communication.

In the context of the invention, an electric vehicle is understood to mean an electrically powered single- or multi-track vehicle and in particular a road vehicle. Preferably, the electric vehicle is a light electric vehicle, as for instance an electric two-wheeler or three-wheeler or an electric bicycle, pedelec, scooter, wheelchair, quad bike or kart. Particularly preferred is a light electric vehicle with an empty weight of not more than 500 kg, furthermore preferred not more than 350 kg, in each case without accessories as for example batteries.

According to the invention, the electric vehicle comprises at least one on-board power supply system for energy supply of an electric drive unit of the electric vehicle, a control unit suitable for communication with a module and at least one interface connected to the on-board power supply system and the control unit for connection with the module, which interface provides a first element of a plug connection.

The module comprises at least one electric arrangement, a module control unit for communication with the control unit of the electric vehicle, and a connecting element connected with the electric arrangement and the module control unit, which provides a second element of the plug connection. The interface of the electric vehicle is separably connectable to the connecting element of the module, in particular mechanically connectable, for connecting the electric arrangement of the module with the on-board power supply system of the electric vehicle. Vehicle and module can certainly comprise further components, in particular one or more switching units, which switch the connection between the on-board power supply system and the module, that are at first however not discussed in detail here.

According to the invention, the interface of the electric vehicle comprises a first NFC-device and the connecting element comprises a second NFC-device, which are provided and suitable for near field communication with each other, for connecting the control device of the electric vehicle with the module control unit.

The on-board power supply system of the electric vehicle according to the invention is designed for energy supply of the electric drive unit and connects at least the drive unit with the at least one interface. The on-board power supply system can certainly in general connect further accordingly formed interfaces, electric components or assemblies of the vehicle, as for example one or more internal batteries, generators, fuel cells, DC/DC converters, motors or other components.

Due to the requirement concerning an energy supply of the electric drive unit, the on-board power supply system is preferably designed for an electric current of at least 3 A, particularly at least 5 A and advantageously 100 A. The can be chosen adequately in form of a DC voltage or an AC voltage. Advantageous is a voltage of 10V-200V, in particular 24V-120V and in particular 60V-120V. According to one embodiment, the on-board power supply system is a direct current power supply system, in particular a 60V DC power supply system (peak voltage).

Based on arrangement and vehicle type, according to one embodiment a separate auxiliary on-board supply system may be provided besides the on-board power supply system, supplying additional electric assemblies such as controls, instruments, operating elements and/or lighting devices with electric energy. Particularly preferred the auxiliary on-board supply system is designed for a voltage of 12V or 14V. The auxiliary on-board supply system may comprise its own voltage supply, for example a battery, or may be supplied by the on-board power supply system for instance by means of a converter. Additionally or alternatively, the on-board power supply system can be suitable for several levels of voltage, for example 60V and 120V peak voltage and, respectively, 48V and 96V nominal voltage, for providing for example speed charging of a battery.

In the context of the present invention, a battery is understood to certainly mean a rechargeable battery, as for example one or more accumulators.

The electric drive unit according to the invention is used for transformation of electric energy into mechanical energy and can comprise for example one or more electric motors. In this context, the electric drive unit is used preferably as main drive; alternatively or additionally it is however also conceivable that the electric drive unit is used as auxiliary drive, for instance with electric bicycles in addition to a pedal drive.

The electric drive unit can be formed as direct drive, i.e. as drive without gear mechanism, which is advantageous concerning the energy efficiency. With a light electric vehicle, the electric drive unit is preferably a disc motor. Particularly preferred, the drive unit is a geared motor. Depending on the design of the drive unit, a motor control is provided that is formed for control of the drive power, for instance by means of current and/or voltage control and/or pulse width modulation (PWM).

The at least one interface of the vehicle is formed for connection to the connecting element of the module. Interface and connecting element can in this context be of any suitable design that provides a safe electrical connection between module and on-board power supply system. Certainly, interface and connecting element should be designed correspondingly mechanically adapted to each other. According to the invention, the interface and the connecting element are provided in form of a plug connection. This provides an excellent operability and easy connecting of modules with the vehicle. Preferably, the connecting element and the interface are provided as plug elements that fit to each other. Preferably, the interface is provided in form of a plug and the connecting element is provided in form of a socket.

According to the invention, the interface on the side of the vehicle is at least connected to the on-board power supply system and to the control unit, while the connecting element on the side of the module is at least connected to the electric arrangement and to the module control. These internal connections are provided on basis of conductors and can be provided permanent, separable or switchable. It is apparent that the connections should be provided adapted to the concerning voltages and current.

In view of potential handling by vehicle users, all current-carrying parts should be formed suitably protected against accidental contact, accordingly also interface and connecting element.

The electric module according to the invention comprises beside the connecting element furthermore an electric arrangement, as already mentioned. The electric arrangement is designed for connection to the on-board power supply system and can be of any suitable design. In the simplest case, it can for example be an electric conductor configuration which is formed for connection to the on-board power supply system via the connecting element and which for instance connects the on-board power supply system, if required by means of another plug-in connector, with further components or with another module. In particular, the electric arrangement comprises however one or more electric or electronic components and/or circuits.

Preferably, the electric arrangement is a power device. The definition of power device comprises in the context of the present invention all electric circuit arrangements and components that are formed for connection to the on-board power supply system or to the drive unit and particularly for supply of electric energy to the drive unit or for dissipation of electric energy generated by the drive unit. The latter can particularly then be the case when the drive unit is used as regenerative brake or as generator. Preferably, the power device is designed for the supply or for the dissipation of an electric current of at least 1 A, preferred of at least 5 A, and particularly preferred of at least 100 A, respectively.

Preferably, the electric arrangement is a voltage or current source, i.e. an energy source, and comprises for example a battery, a charging device, a solar panel, a fuel cell and/or a generator. The module can thus particularly be formed as charging device or charging station, i.e. as “charging module”.

Alternatively or additionally, the electric arrangement can also be formed as electrical load, i.e. as energy drain, and comprise for example a brake resistor, a battery in charging mode, a converter or a power feed-in for the electric grid, if required with an inverter for a “vehicle-to-grid” coupling.

For communication with the at least one module, the control device may comprise in particular one or more micro-processors or an adequate computer unit with an adequate programming stored in a date memory.

The control unit may be provided in one part or in several parts, wherein a central control unit is preferred. The control unit may be provided integrally with other components of the vehicle, for example with a motor control of the electric drive unit. The control unit preferably corresponds to an Energybus-controller (EBC).

The module control may comprise for example a micro-controller, a micro-processor or another suitable electric element, as the case may be with an adequate programming, such that a communication with the control device is possible.

As mentioned at the beginning, the interface of the electric vehicle further comprises a first NFC-unit and the connecting element comprises a second NFC-unit, which are configured to near-field communication with each other, to connect the control device of the electric vehicle with the module control.

In this regard a connection between the control device and the module control is to be understood as a data connection, which allows at least a unidirectional and preferably a bidirectional communication between the aforementioned components.

Both near-field communication devices are configured for near-field communication and therefore for wireless communication with each other. Here, the term “near-field communication” is to be understood as a wireless communication which does not provide a significant far-field. The communication may happen inductively, capacitively or optically. The operational distance of the communication preferably is less than 10 cm and in particular less than 2 cm. For communication the NFC-units may use a suitable protocol, as for example ISO 14443, 18092, 21481, ECMA 340, 352, 356, 362 or ETSI TS 102 190. Particularly preferred comprises the near-field communication a frequency within the ISM-band, in particular of 13.56 MHz.

As initially already discussed, a reliable communication between the control unit of the vehicle and the module control can be provided by the use of the NFC-units. This particularly in a case, where the plug connections are exposed to weather, which easily may lead to corrosion of contacts and dirty contacts. While this is regularly not a problem with regard to the high currents occurring at the connection between the on-board power supply system and the electric arrangement, contacts of electrically conducting data-connections are more sensitive by far. Correspondent problems of contact advantageously are avoided by the invention. Thereby the use of a near-field communication simultaneously increases the security of the communication, improves interference resistance and facilitates the addressing compared to a use of for example Wi-Fi, WLAN or RFID. Further, as already mentioned, the invention advantageously provides a galvanic separation at least between the control device and the module control.

The first and second NFC-units may comprise any suitable configuration for providing a near-field communication with each other. According to one preferred embodiment at least one of the two NFC-units is integrally formed with the interface and, respectively, the connecting element, thereby providing a very compact configuration. Here, the respective NFC-unit may be arranged enclosed in a housing of the interface and, respectively, the connecting element in such a manner, that it is protected against weather and, respectively, damage. According to one embodiment at least one of the NFC-units comprises an electromagnetic effective shielding. Thus, the communication can be restricted in a safe manner to the aforementioned operating distance, which again enhances the security of communication.

As initially mentioned, the NFC-units allow at least a unidirectional communication. Preferably, both NFC-units are configured to bidirectional communication. It is particularly preferred that both NFC-units are configured active. A supply by voltage here may for example be provided via the auxiliary on-board power supply system.

According to a further alternative or additional embodiment, the NFC-units may additionally be configured to transfer of energy, in particular for electric energy supply of the control unit of the electric vehicle and/or of the module control.

According to the present embodiment, the NFC-units allow for transfer of electric energy in addition to at the same time providing a communication and, respectively, data connection, which is particular advantageous. Here, on one hand the electric energy supply of the control unit of the vehicle by the module is possible, for example in case of a completely drained internal battery, or on the other hand the electric energy supply of the module control by a voltage supply source present on the vehicles side. Correspondingly, the present embodiment allows for a communication between the control unit and the module control, even in the case of a completely emptied vehicle battery and under retention of a galvanic separation.

Within the scope of the present embodiment, a transfer of energy and, respectively, an electric energy supply have to be understood as transfer of electric power of at least 1 Watt up to for example 24 Watt maximum.

As initially mentioned, the electric vehicle may further comprise an auxiliary on-board power supply system, which supplies further electric structural components as control units, armatures, operating elements and/or illuminating units with electric energy. The auxiliary on-board power supply system in particular may be configured for electric energy supply of the control unit.

According to a further embodiment, the NFC-units are configured to transfer energy between the auxiliary on-board power supply system and the module. In particular, here a connection may be provided between the auxiliary on-board power supply system and an auxiliary module net of the module. The auxiliary on-board power supply system here for example may be connected with the module control, such that correspondingly the module control can be supplied with electric energy from the auxiliary on-board power supply system. Alternatively or additionally, for example as initially mentioned in the case of a charging module, the auxiliary on-board power supply system may be connected with a voltage supply source, for example with a 12V—or 14V—power supply, to provide—as the case may be—the module control and the control unit of the electric vehicle with electric energy necessary for proper operation of these components.

The NFC-units may have any suitable configuration for electric energy transfer. The electric energy transfer here may be provided capacitively or inductively.

According to one embodiment the first and the second NFC-units each comprise an NFC-coil, the coil-axes of which are orthogonal to the plug-direction and parallel to each other when the interface and the connecting element are connected as intended. Thus, on one hand a particular effective transmission of signals and on the other hand an efficient transfer of energy via the NFC-units are ensured.

The first and the second NFC-unit in particular may be configured such that its coil-axes essentially completely overlap, for example with ±2 mm tolerance, as the case may be, when plug-connection is connected as intended.

Advantageously, the interface and the connecting element are configured to galvanically connect the electric arrangement of the module with the on-board power supply system of the electric vehicle, while the control unit and the module control are galvanically separated. Thus, high voltages and/or currents may be transferred between the electric arrangement of the module and the on-board power supply system of the electric vehicle, while an (inadvertent) transfer of overvoltages and/or overcurrents between the control unit and the module control can be prohibited. Therefore, the risk of an operation error is further minimized.

According to a further embodiment, the interface and the connecting element may be configured to galvanically connect the electric arrangement of the module with the on-board power supply system of the electric vehicle on multiple voltage levels. As initially discussed, this can be advantageous for example for quick-charging of the battery. Preferably, the on-board power supply system and/or the electric arrangement of the module comprise two voltage levels on conductors, separated from each other.

Advantageously, the interface and the connecting element comprise at least one first contact element for connection of the on-board power supply system with the electric arrangement on a first voltage level and at least one second contact element for connection of the on-board power supply system of the electric vehicle with the electric arrangement on a second, different voltage level. Here, the second voltage level may correspond to a quick-charging conductor. In the case of a charging module the electric arrangement correspondingly may comprise a voltage supply, which provided at least two voltages.

In a further alternative or additional embodiment the first and/or the second NFC-unit may comprise an NFC-control. This may in particular be configured to communication with the control unit and may therefore allow for an identification of the concerning NFC-unit. The present embodiment particularly may be advantageous, if the electric vehicle is provided with more than one interface. In this case it is possible to determine which module is connected with which interface, such that an assignment of them is possible. It is particularly advantageous, if the NFC-control is logically addressable. This allows for an analysis of the current circuits and as the case may be of the data circuits and, respectively, data communication.

Advantageously, the NFC-control is configured for measurement of current and/or voltage on the on-board power supply system and, respectively, on the auxiliary on-board power supply system, for example with a suitable measuring unit. This embodiment allows monitoring of the electric connection and, respectively, of the charging process. Alternatively or additionally the NFC-control is configured to control of a switching unit and/or of a locking drive, as discussed in the following.

The NFC-control can be formed integrally with the concerning NFC-unit or may be provided as separate control. According to one embodiment the NFC-control of the second NFC-unit is formed integrally with the module control, for example in a microprocessor.

According to a further alternative or additional embodiment of the invention, a first locking element is arranged at the interface. A second locking element configured for engagement with the first interlocking element is arranged at the connecting element. At least one of locking elements may be movable between a free position (unlocked) and an interlocking position (locked). In the free position the connecting element is separable from the interface. In the interlocking position the connecting element is mechanically interlocked with the interface. This embodiment provides the possibility that in addition to an electric connection between the vehicle and the module in a connected operating mode at the same time a mechanical locking of the components may be accomplished.

The present embodiment allows for a secure connection between the vehicle and the module, which enhances the operational safety and reduces the risk of intervention of unauthorized persons. Here, it is in particular advantageous that the electric connection as well as the mechanical locking occurs via the at least one interface of the vehicle and the connecting element of the module. The system is therefore particularly user friendly and may be operated quick and easy.

The locking means provided according to an embodiment of the invention can be of any suitable design to lock connecting element and interface with each other in a locking position, i.e., mechanically lock them with each other, so that accidental disconnection of the module from the bicycle is being avoided. Thus it is for example possible to avoid a disconnection of bicycle and module “under load” which considerably increases safety of operation. Furthermore, depending on the design, an unauthorized removal of the module from the bicycle can also be avoided, whereby a certain anti-theft protection is given.

Preferably, the locking means are designed as corresponding elements. In this context, one of the locking elements can for example be formed as groove, recess or opening in which the respective other locking means engages, which is preferably formed as pin or bolt or locking bar. Particularly preferred, the second locking means is formed for positive connection to the first locking means.

The locking means can be formed in one or multiple parts, whereby the first locking means is preferably formed integrally with the interface. Preferably, the second locking means is formed integrally with the connecting element.

If the vehicle comprises multiple interfaces, preferably each of the interfaces should comprise an assigned locking means.

As discussed in the preceding, at least the first or the second locking means can be movable from a free position into a locking position and vice versa. However, also both locking means can be formed movable. Preferably at least the second one, i.e. the locking means on the module side, is formed movable, whereby the interface on the vehicle side can be advantageously formed very simple and compact.

The respective locking means can for instance be formed in such a way that it is linearly or rotatably movable from the free position into the locking position. Depending on the application, the respective locking means can however also be formed for several superimposed movements, for example alternatively or additionally pivotable or rotatable, whereby the locking means is preferably movable from the free position to the locking position by a movement particularly easy to realize. Preferably, at least one locking means is movable in a direction, perpendicular to a direction of connection or disconnection of interface and connecting element, i.e. perpendicular to the direction in which interface or connecting element have to be moved to be engaged with each other or to disconnect the connection.

In the context of the present invention, a “free position” or “unlocking position” is understood to mean a position of the locking means that generally allows disconnecting of the connecting element from the interface. Certainly, another safety device or a fastener can be arranged at vehicle and/or module, which even in the free position prevents an independent separation of the connecting element from the interface, as for example an additional mechanical and/or magnetic locking or fixing.

In the locking position, as already discussed at the beginning, connecting element and interface are locked with each other, i.e. mechanically locked in such a way that an accidental disconnection of the module from the vehicle is being avoided. In this position, both the locking means are engaged with each other in such a way that a disconnection of connecting element and interface, i.e. a substantial movement of these components relative to each other in the disconnection direction, is blocked. The holding force of the connection between connecting element and interface by the locking means is preferred in such a way that in the locked state, pulling apart of interface from connecting element in normal use is being prevented, however with the help of a person's bodyweight is possible in such a manner that the elements of the interface are not damaged. For this purpose, the locked connection between connecting element and interface should preferably be designed for a holding force of 500 N and preferred 730 N. In one embodiment, an autonomous releasing of the locking however can be provided to avoid damage of the components, for example if a maximum safety holding force is exceeded. This provides a further enhancement of the vehicle system. The predetermined safety holding force for example can be 500 N and in particular 730 N.

In an additional or alternative embodiment, the interface and the connecting element are formed in such a manner that an autonomous disengagement occurs when a safety holding force is exceeded by a force in axial direction of the plug connection.

Alternatively or additionally, according to a further embodiment there may be provided a predetermined breaking point at the interface and/or the connecting element, which separates any contact and therefore the vehicle and the module from each other in case a predetermined vertical safety holding force is exceeded, i.e., in a direction orthogonal to the axial direction of the plug connection. The predetermined vertical safety holding force for example may be 600N and in particular 800N.

The locking means can be formed to be movable between the free position and the locking position with a motorized locking drive, as for example by means of one or more springs and/or a pneumatic, hydraulic or otherwise motorized locking drive.

According to a preferred embodiment, an electrically operable locking drive is arranged at the first and/or second locking means that is designed to move at least one, i.e. the first and/or the second of the locking means between the free position and the locking position.

For this purpose, the electrically operable locking drive can be of any suitable design and can for example be formed as electric motor. The locking drive can be connected directly as well as via another mechanical system, for example a worm drive or a gear wheel system, to the respective locking means, to move the respective locking means between the free position and the locking position.

The drive for the locking means can be arranged both at the electric vehicle and at the module. Provided that both locking means are formed movable, a corresponding locking drive can be arranged at each of the electric vehicle and the module.

Particularly preferred, the locking drive is arranged at the connecting element on the module side. Hereby, a particularly simple and compact interface on the vehicle side is made possible. Also therefore in case of a charging module, mechanically movable components are not arranged on the vehicle side, whereby a particularly advantageous protection against external influences such as for example moisture and mechanical damage by vibrations during operation of the vehicle is given. Furthermore, for example in case of malfunctions, the locking drive can be accessed independently from the electric vehicle to easily disconnect vehicle and module from each other in case of for example repairs and maintenance.

The activation of the locking drive can take place by any suitable devices. It is for instance conceivable to provide a switch contact that activates the locking drive when connecting the connecting element to the interface to lock the components. For example a mechanical sensor or also a contactless sensor, as for instance an acoustic or an optical sensor, can be used as switch contact.

According to one embodiment, the module control is used to set the position of the second locking means and to accordingly control the locking drive.

Thus it is for instance conceivable that in case of a charging module, the module control activates the locking drive on connection of interface to connecting element and locks the locking means. After completed charging process of the battery present in the vehicle, the locking drive is again activated and interface and connecting element are accordingly unlocked automatically. Hereby can be prevented that the charging process is interrupted early, which can be disadvantageous for conventional batteries.

Alternatively or additionally, the module control can be connected to a control panel so that locking and/or unlocking can only take place after entry of a PIN code. Thus, an unauthorized removal of a module or of the vehicle can be prevented especially in public spaces.

According to a further embodiment, the control device is configured to send a first activation signal to the at least one locking drive to lock the connecting element to the interface.

Further or alternatively, the control device is configured to send a deactivating signal to the at least one locking drive and to unlock the connecting element and the interface.

For this, the control device can be connected for example with an appropriate user control panel, such that the deactivating signal is sent according to a user's command, for example if/when the user demands a disconnection of the module and the vehicle. Additionally or alternatively the control device can be configured to send the activation signal automatically, for example if/when the user releases the locking by a mobile device (smartphone or similar).

The activation signal can in this context be sent to the locking drive directly by the control device or indirectly for example via the module control. The activation signal can in this context be an accordingly suitable, preferably electric signal; particularly preferred, the activation signal is a digital signal. The signal also can be transmitted via Internet, such that releasing can be sent by the user via a mobile internet device (mobile phone), when he is on site, or such that releasing can be done by the legitimate user from a distance.

According to a further alternative or additional embodiment, the module control in particular is configured to send an identification signal to the control device during connecting of the connecting element and the interface.

For this, the control device additionally can be configured to receive the identification signal, to compare it with at least one compatibility parameter and to execute one or more of the following method steps if the identification signal conforms to the compatibility parameter.

Such a method step for example may comprise sending of an activating signal to at least one switching device to connect the electric arrangement with the on-board power supply system. A further example of such a further method step is the execution of an interlocking step by the aforementioned locking drive. In other words, in a case that the identification signal conforms to the comparability parameter a first activation signal may be sent to the at least one locking drive to interlock the connecting element and the interface, and/or a second activation signal may be sent to the at least one switching device to connect the electric arrangement with the on-board power supply system. The chronology of the first activation signal and the second activation signal can be chosen according to the use. In this context the first activation signal may be send before, simultaneously or after the second activation signal.

Advantageously, thus according to the present embodiment, it is envisaged that the interface of the electric vehicle is interlocked with the connecting element only if compatibility and respectively authorization therefore is assured. Thus it is for example possible to assure that only compatible and respectively authorized vehicles can be used and interlocked with the modules, for example a charging station, or that only compatible and respectively authorized modules, for example original batteries, con be used and interlocked with the vehicle. The present compatibility check further increases reliability of operation.

The module control can, as mentioned at the beginning, be designed in such a way that the identification signal is being sent to the control device at least upon connection of the connecting element of the module to the interface of the electric vehicle, or short before or short thereafter.

The identification signal enables the control device to do a comparison with at least one compatibility parameter and thus a decision concerning the compatibility or eligibility for operation of the module with the vehicle. For instance, the identification signal can enable the control device to decide concerning the compatibility of the electric arrangement of the module with the on-board power supply system, i.e. a check if the arrangement can be safely connected to the on-board power supply system. Preferably, the identification signal is a digital signal, which is in particular advantageous with regard to reliability.

In the simplest case, the identification signal allows an identification of the module, so that, if necessary after scanning of an appropriate memory unit provided in the control device, a verification is possible if the module may be connected to the electric vehicle or if the module is compatible with the on-board power supply system and thus with the vehicle. Thus, the identification signal can correspond to an identification parameter, such as for example an access or PIN code, a serial number and/or a model ID, if required with manufacturer ID. Alternatively or additionally, the identification signal can correspond to a functional ID regarding the functionality of the electric component, such as for example “energy source” or “energy drain”, or “battery”, “charging device” or “solar panel”.

The at least one compatibility parameter can for example comprise one or more reference values and/or one or more threshold values. Certainly, the control device can be formed for comparison of several compatibility parameters. The at least one compatibility parameter can be preset in the control device or preferably be obtained from a memory unit by means of the control device. Alternatively or additionally, a measuring unit can be connected to the control unit, to measure an electric variable of the on-board power supply system, as for example voltage or current flow, and to detect accordingly one or more compatibility parameters out of it. In this connection the measuring unit may be read for example via one of the NFC-devices.

As already mentioned in the preceding according to one embodiment, after occurred compatibility check, thus in case that the identification signal corresponds to the compatibility parameter, the control device sends a second activation signal to at least one switch unit to connect the electric arrangement to the on-board power supply system.

The switch unit provides a switchable, separable connection of the electric arrangement of the module to the on-board power supply system. Generally, the switch unit should be formed in such a way that before activation of the switch unit by the control device, the electric arrangement is safely disconnected from the on-board power supply system, hence also in the period between the connecting of the connecting element to the interface and the activation of the switch unit by the control device.

The present design thus provides a safe galvanic disconnection of the electric arrangement of the module from the on-board power supply system before the compatibility check. In case that the identification signal corresponds to the compatibility parameter, the previously described locking of interface and connecting element by sending the first activation signal can for example take place at first, and then the electrical connection between on-board power supply system and electric arrangement of the module is established. Consequently, the safety of operation is further increased due to initially ensuring the correct connection and locking of the module at the vehicle, before the electrical connection between on-board power supply system and electric arrangement of the module is being established.

Preferably, the control device is hence formed to initially send the first activation signal to the locking drive and then send the second activation signal to the switch unit.

For operation of the switch unit, the switch unit is suitably connected to the control device for reception of the second activation signal, whereby besides a direct connection certainly also an indirect connection, for example via further components of the vehicle or the module, as for example one of the NFC-devices or the module control, is possible.

The switch unit can be formed for single-pole or multi-pole switching of the connection between the electric arrangement and on-board power supply system, as long as it is assured that before activation by the control device, no significant electric current flows between the arrangement and the on-board power supply system. Preferably, the switch unit is formed for all-pole switching of the connection between electric arrangement and on-board power supply system, which further advantageously increases the safety of operation. The switch unit can be formed discrete, for example as relay or contactor, but also as integrated circuit, for example as MOSFET.

In this context, the switch unit can be formed in one or multiple parts and generally be arranged in the vehicle, which is advantageous concerning weight and overall size of the module. Preferably, the switch unit is however provided in the at least one module. Hereby, the on-board power supply system can be extended in a simple way by addition of further interfaces, similarly to a bus system. In case of multiple modules, each module certainly should comprise an appropriate switch unit.

Preferably, the switch unit is formed integrally with the connecting element, whereby a particularly compact design is provided. Particularly preferred, the module control is formed integrally with the connecting element and in particular integrally with the switch unit. Advantageously, an optical indicator, such as for example a LED, is connected to the switch unit for display of the connection state.

According to a preferred embodiment of the invention, the control device can be designed to detect at least one electric operating parameter of the arrangement from the identification signal and to compare the operating parameter with at least one electric compatibility parameter of the on-board power supply system.

Hereby, an advantageous compatibility check based on the electrical properties of the systems to be connected is made possible, which further increases the safety of the system. The electric operating parameter of the arrangement and the electric compatibility parameter of the on-board power supply system can in this context be any electric variable or range suitable for the comparison, such as for example voltage, current, power and/or battery capacity.

Certainly, it can be provided to compare several electric operating parameters of the arrangement with corresponding compatibility parameters.

The module control can for example be formed to retrieve the at least one electric operating parameter from a memory on the module side and to subsequently send a corresponding identification signal to the control unit of the vehicle. This is particularly then advantageous when the electric operating parameter corresponds to an operating range of the electric arrangement of the module, for instance to the applicable voltage range and/or a maximum applicable current of the arrangement.

Alternatively or additionally, the module control can comprise at least one measuring unit each, to detect the electric operating parameter by measuring. In case of a voltage source, such as a battery or a charging device, it is thus possible to determine the present voltage and to send a corresponding identification signal to the control device.

Similarly, the control device can, as discussed in the preceding, determine the at least one electric compatibility parameter of the on-board power supply system from the memory unit or a measuring unit provided in the vehicle.

Particularly preferred, the module control comprises at least one measuring unit for measuring the voltage of the electric arrangement as well as the control device comprises a measuring unit on the vehicle side for measuring the voltage of the on-board power supply system. Advantageously, the module control can comprise a second measuring unit to determine whether the on-board power supply system shows a voltage after the connection with one of the interfaces.

Preferably, the module control transmits the identification signal, which corresponds at least to the voltage of the electric arrangement. The control device detects the voltage of the electric arrangement from the identification signal and compares the voltage of the electric arrangement to the voltage of the on-board power supply system. The control device sends in this case the activation signal or the activation signals if the two voltages do not substantially differ from each other, i.e., preferably by not more than ±0.5 V, particularly not more than ±0.15 V and particularly preferred not more than ±0.05 V. In the event, that the plug connection is configured to provide a galvanic connection of the electric arrangement of the module with the on-board power supply system of the vehicle on several levels of voltage, according to a further alternative or additional embodiment, the control devise may, as already mentioned, be configured to connect the one level of voltage with the on-board power supply system, which conforms to the voltage of the on-board power supply system (actual voltage and/or nominal voltage). This choice on hand provides a very flexible use of the plug connection.

Certainly, depending on the application, it is not excluded that the identification signal corresponds to multiple operating parameters and/or identification parameters and that the control device is formed with corresponding compatibility parameters for comparison of these operating and/or identification parameters.

As already discussed in the preceding, the electric vehicle and the module according to the invention are connectable by a plug-in connection. In the context, a plug-in connection and a plug-in connector are understood to mean a separable component, which is to connect to a corresponding component and which provides a galvanic connection, i.e., based on a conductor, between the on-board power supply system and the electric arrangement, which galvanic connection is separable.

The plug-in connector should preferably be formed in such a way that a safe connection between on-board power supply system of the vehicle and the electric arrangement of the module is possible. Particularly, the plug-in connector should be adapted to the electric requirements of the respective arrangement, particularly concerning current and voltage. Advantageously, the plug-in connector is designed for an electric current of at least 3 A, particularly at least 5 A and respectively at least 60 A-100 A at a voltage of 10 V-200 V, in particular 12 V-120 V (peak voltage).

Conventional plug-in connectors and respectively plug-in connections are for instance receptacles that are designed as sockets for plugs. It is possible in this context to design the connecting element or the interface as receptacle or plug. Advantageously, as particularly low-maintenance and easy-care, the connecting element on the module side is designed as receptacle. In this case, the interface can be formed as plug corresponding to the receptacle.

Preferably, the plug-in connection comprises at least two electric contacts, so that the on-board power supply system can be connected to the electric arrangement. Particularly preferred, the plug-in connection comprises three electric contacts, for example for connection of +60 V, −120 V and ground connection between the on-board power supply system and the electric arrangement. Any contacts for a transmission of a communication signal, as for example of a CAN bus system and as the case may be of the auxiliary on-board supply system, discussed in the preceding, to the module, are not necessary.

According to a particularly preferred embodiment of the invention, a flexible connection means is arranged between the interface and the electric vehicle and/or the connecting element and the module. Hereby, the operability of the vehicle system is further simplified and a connection of the module to the vehicle is further facilitated.

In this context, the connection means can be formed in one or multiple parts. Preferably, the connection means is built tubular or cable-like and comprises, besides appropriate electric conductors for connecting of the on-board power supply system with the electric arrangement of the module, a retaining element made of a material resisting mechanical stress, as for example a metallic armor or a steel rope. Preferably, the retaining element is provided integral with the interface and the connecting element, respectively. The retaining element may be adhered to the interface and the connecting element, respectively, in such a manner, that these components cannot be nondestructively separated from each other.

By the use of the flexible connection means, enhanced connection options between module and electric vehicle result for the vehicle user. For example, bicycles can be parked in a spaced manner at a charging station and be connected to and locked with this charging station. It is also for example possible to connect and to lock modules with the vehicle, whereby the modules however can be flexibly positioned, for example at the handle bar of the vehicle. Furthermore, the vehicle can, for instance with the connection means, be attached particularly easy to an object, as for example a bicycle rack, and additionally be connected to the module.

Particularly preferred is an embodiment where an additional receptacle with a locking means for the interface is present on the vehicle, so that the flexible connection means with the interface can be inserted into and locked with the receptacle. Hereby, use of the interface with the flexible connection means also as “cable lock” is possible.

According to another preferred embodiment, a magnetic fixing is provided to fix in place and to loosely position the interface and the connecting element with each other. The magnetic fixing can be arranged both at the connecting element and/or at the interface. The fixing allows an exact positioning of the interface and the connecting element in relation to each other, to allow a failure-free and exact locking. Furthermore, hereby the connecting element stays at the interface also after unlocking occurred, so that the connecting element, for example when formed with a flexible connection means, does not leave its position uncontrolled and gets accidentally damaged.

Advantageously, the electric vehicle is formed for connection of two or more modules. Especially here, distinct advantages result from the compatibility check. Certainly, the electric vehicle should preferably comprise two or more interfaces.

The switch unit can in this case be formed for separate connecting of the two or more modules to the on-board power supply system so that in case of an incompatibility, the corresponding module will in fact not be connected to the on-board power supply system, however a connection of the other modules is possible.

Alternatively or additionally, the control unit can preferably comprise a priority control in case of connection of two or more modules, to in addition to the compatibility check, determine based on the priority if the respective module can be connected to the on-board power supply system. To this end, the control unit can preferably be adapted to compare the identification signal with one or more priority parameters, so that the activation signal is only being sent to the switch unit if the identification signal corresponds to the at least one priority parameter.

For example in case of a connection of multiple battery modules, it is conceivable to prioritize based on the present power requirement of the electric drive unit. Likewise it is possible to provide prioritization based on the module type, so that for example at first the energy of a solar panel is being used for the drive, and a battery module is only then being connected when the solar panel does not supply sufficient electric power. Certainly, also a module that is not connected can nevertheless be locked with the vehicle.

Further, the electric vehicle can comprise a communications network, separate from the on-board power supply system, that connects the control device to the at least one interface. The communications network here is used for transmission of at least the identification signal from the module control, after the module has been connected to the interface of the vehicle. Certainly, the communications network can be formed for connection of other components of the vehicle or the module, such as for example of the locking drive, the switch unit, an instrument board, an operating device and/or a motor control. The communications network may in this context for example comprise electric signal lines and/or wireless communication lines; preferably, the communication network is an optical network, i.e. a communications network accordingly formed with optical signal lines and transmitter/receiver arrangements. In such a case, the interface and the connecting element comprise optical sender-/receiver-arrangements, which are connected at least to the concerning NFC-device. Preferably, the communications network is formed as bus system with an adequate protocol, in particular preferred the communications network is a CAN bus system (CAN high, CAN low). Particularly preferred, control unit and module control are formed for communication via the CAN-open protocol. In this case the NFC-devices are configured to convert the CAN-signals (high/low) into a protocol suitable for near-field communication and in turn correspondingly into a CAN-signal (high/low) on the receiver side.

According to another aspect of the present invention, a method is provided for connecting an electric vehicle to a module.

In this regard, the electric vehicle comprises an on-board power supply system for energy supply of an electric drive unit of the electric vehicle, an interface connected to the on-board power supply system for connection with a module and a control unit for communication with the module.

The module comprises an electric arrangement for connection with the on-board power supply system, a connecting element separably connectable with the interface of the electric vehicle, a module control for communication with the control device of the electric vehicle.

According to the instant aspect, the interface and the connecting element are suitable for wireless nearfield communication with each other, such that after the connection of interface and connecting element the module control and the control device of the electric vehicle communicate with each other wireless via the interface and the connecting element.

Within the method according to the present aspect, an identification signal can be sent to the control device, in particular during connecting of the connecting element with the interface, and the identification signal can be received via the control device, can be compared with at least one comparability parameter and if the identification signal conforms to the comparability parameter a following method step can be performed, for example the aforementioned interlocking and/or switching. In particular, within the method the first and/or the second locking means is/are moved from a free position into a locking position to lock the connecting element at the interface.

With regard to the design of the individual components and possible embodiments, reference is made to the preceding description of the modular vehicle system.

The previously explained nearfield communication between an electric vehicle and a module can also be used advantageously in the context of a modular charging system. Another aspect of the present invention thus concerns a modular charging system with a charging unit and at least one module.

The charging unit comprises a charging line and one or more interfaces connected to the charging line for connection of at least one rechargeable module. Further, a control device is provided for communication with the module.

The at least one rechargeable module may comprise a connecting element separably connectable to the interface and an electric arrangement for connection to the charging line. Further, the module may comprise a module control for communication with the control device.

In this regard, the interface of the charging unit may be separably connectable with the connecting element of the module, to connect the electrical arrangement of the module with the charging line. Further, the interface may comprise a first NFC-unit and the connecting element may comprise a second NFC-unit, which are configured for nearfield communication with each other, to connect the control device of the charging unit with the module control (for data communication).

The embodiment according to the present aspect thus also allows an advantageously increased safety of operation when connecting a rechargeable module to a charging unit by means of the nearfield communication according to invention.

The electric arrangement preferably comprises an electric energy storage and particularly preferred a battery arrangement, such as for example one or more accumulators. Preferably, the rechargeable module is thus a battery module.

The charging unit is preferably configured for connection to a power grid, for example a 220V or 110V electric power grid. Preferably, the charging unit comprises a power supply unit that connects the power grid to the charging line and is designed for an adaptation and monitoring, if necessary, of current and/or voltage. The charging line in this context can further be formed according to the previously described on-board power supply system, as the case may be with several voltage levels (60 V, 120 V, 180 V peak voltage) and appropriate separate conduits therefore. It is also possible that appropriate embodiments are provided for different classes of performance, for example 5 A, 15 A, 30 A, 40 A, 60 A.

Concerning the configuration of the individual components of the charging unit and of the rechargeable module, reference is made to the preceding description of the modular vehicle system, wherein the configuration of the components of the charging unit corresponds to the respective components of the vehicle.

The invention is described in the following based on embodiments. It is shown in:

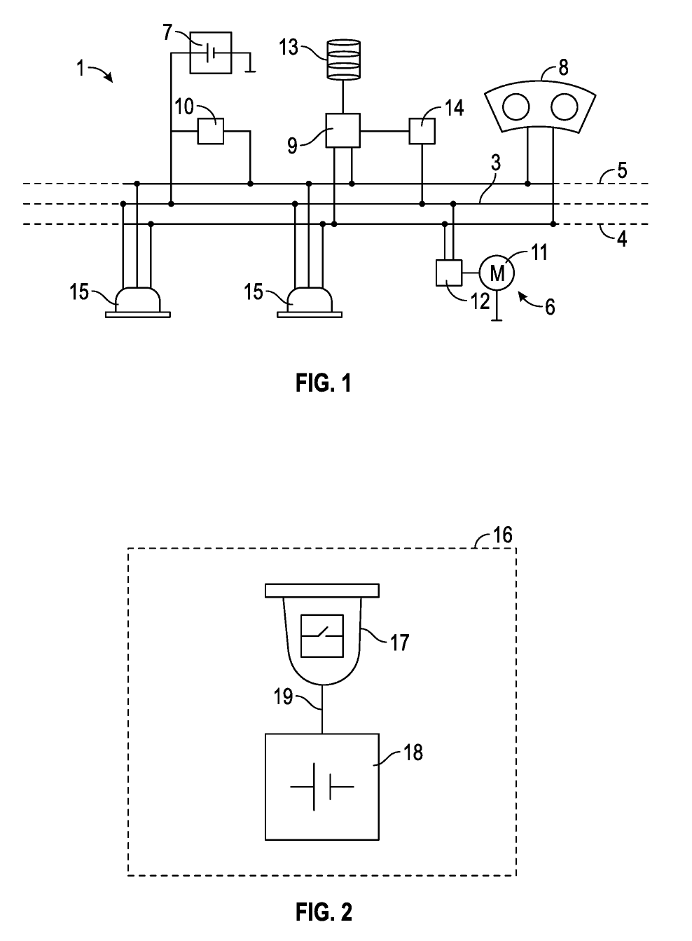

FIG. 1 an embodiment of an electric system of an electric vehicle in a schematic view;

FIG. 2 an embodiment of a module in a schematic view;

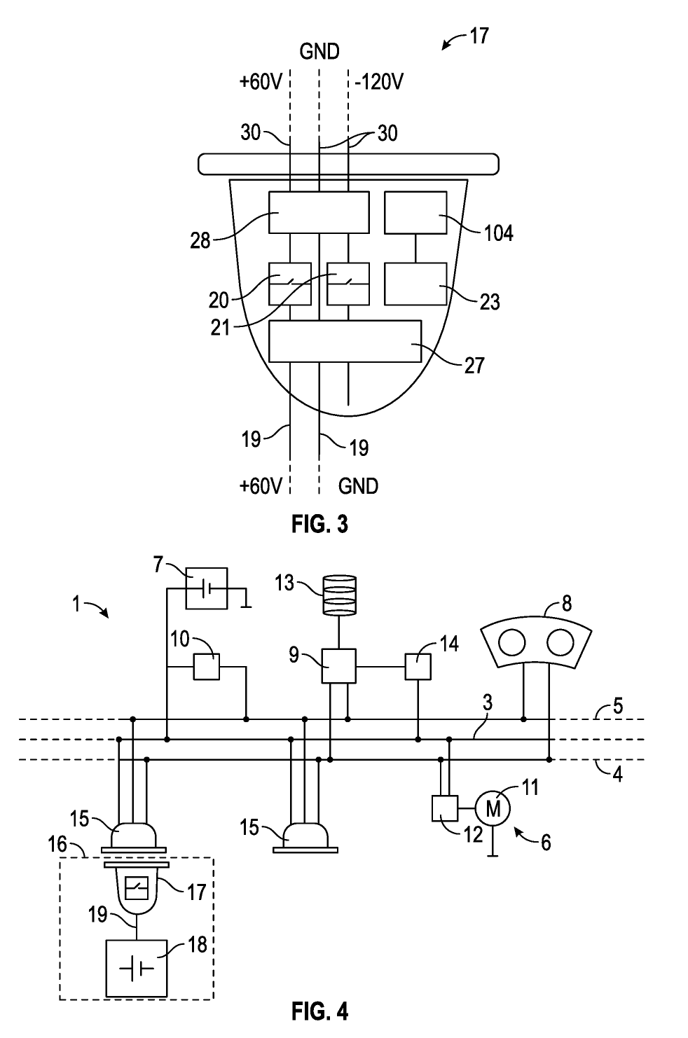

FIG. 3 a detailed view of a connecting element of the module according to FIG. 2;

FIG. 4 the embodiment of the electric system according to FIG. 1 with a connected module according to FIG. 2,

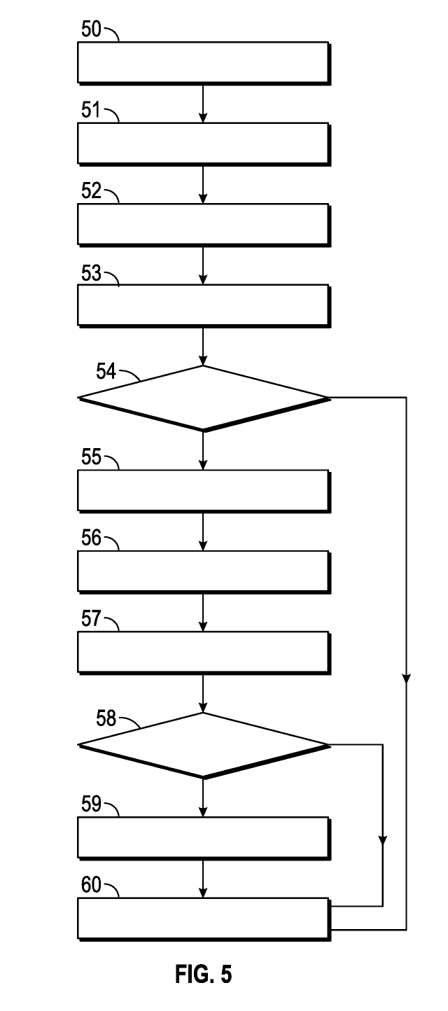

FIG. 5 an embodiment of the communication upon connection of a module with an electric vehicle in a schematic flowchart,

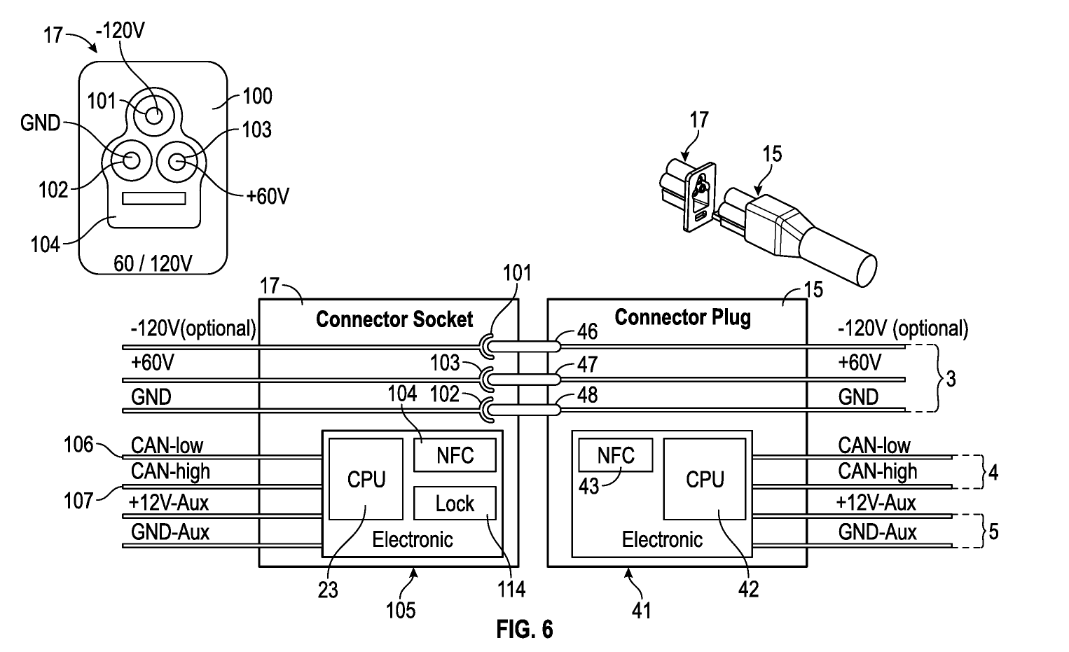

FIG. 6 an exemplary embodiment of a connecting element and an interface in a perspective view with a schematic circuit diagram,

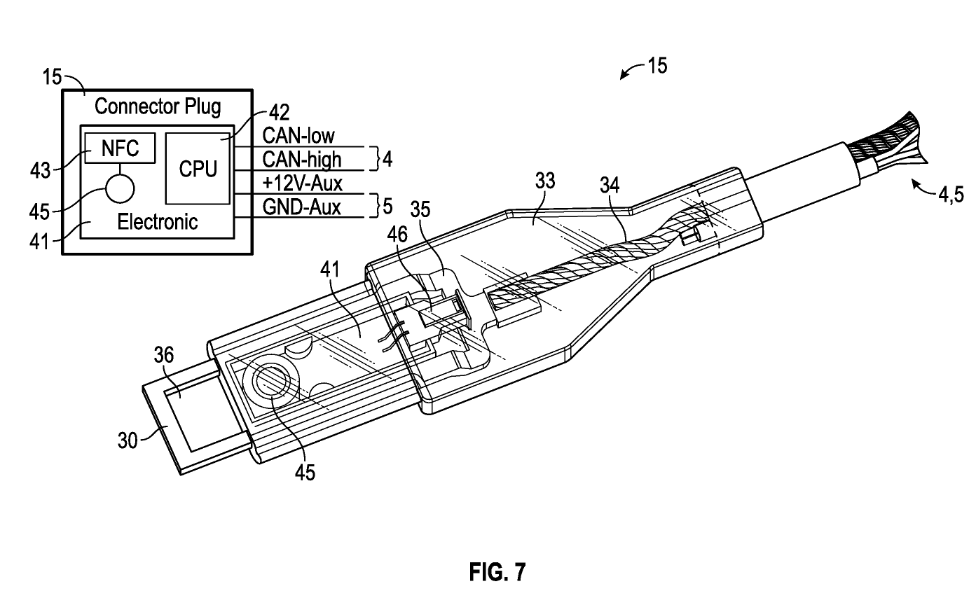

FIG. 7 an exemplary embodiment of the interface of FIG. 6 in a fragmentary perspective view with a schematic circuit diagram, and

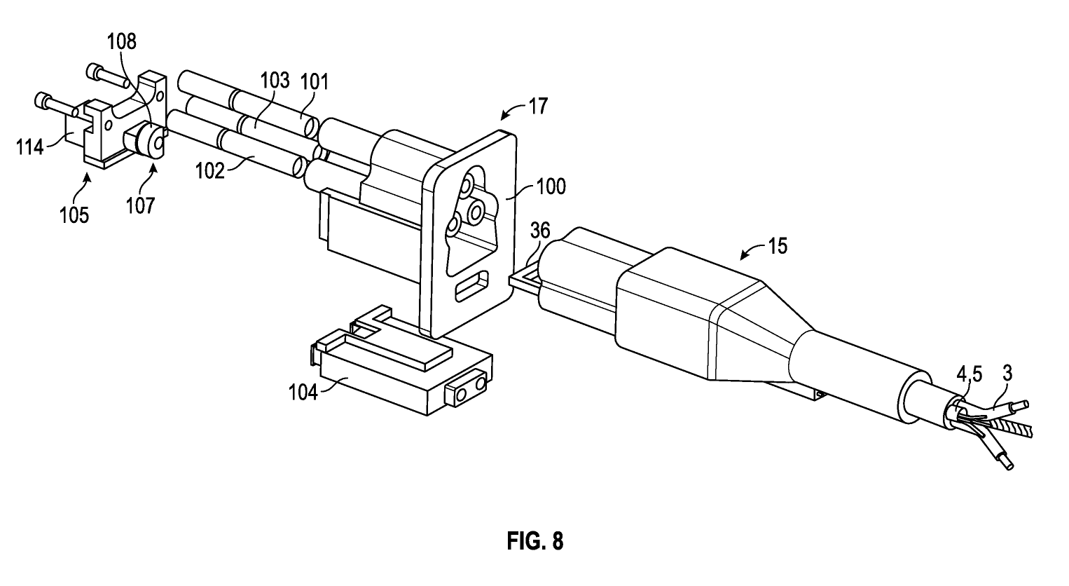

FIG. 8 the connecting element of FIG. 6 in a perspective exploded view.

FIG. 1 shows an electric system 1 of a vehicle 2 according to the invention with three on-board network systems in total, namely an on-board power supply system 3, a CAN bus system 4 and an auxiliary on-board supply system 5. The on-board power supply system 3 is being primarily used for electrical energy supply of an electric drive unit 6 of the vehicle 2. The on-board power supply system 3 is designed as a direct current system with several voltage levels, namely +60 V DC and −120 V DC peak voltage and +48 V DC and respectively −96 V DC nominal voltage for a current of approx. 20 A-100 A. It is being supplied with electrical energy by an internal rechargeable vehicle battery 7. In the following the single voltage levels of the on-board power supply system 3 are designated with reference to the aforementioned peak voltages, even though the nominal voltage deviates therefrom.

The auxiliary on-board supply system 5 is designed for an operating voltage of ±12 V direct current and is being used for electrical energy supply of other vehicle components, such as for example an operating unit 8 and a control device 9. In this context, the auxiliary on-board supply system 5 is being supplied with electrical energy by the battery 7 and an intermediate 60V/12V converter 10.

The CAN bus system 4 is being used for the control and the communication of the vehicle components, as described in the following. The CAN bus system 4 is formed with electrical signal lines in the present case; the communications protocol corresponds to the “CAN-open” protocol according to specification CiA 454 (LEV).

According to the present embodiment, the on-board power supply system 3 comprises three conductors, namely +60V DC, −120V DC and ground. The auxiliary on-board power supply system 5 comprises altogether two conductors, namely +12V DC and ground, while the CAN bus system 4 comprises CAN-high and CAN-low conductors. For better clarity, the single conductors of the aforementioned networks are not shown in FIGS. 1 and 2.

The electric drive unit 6 comprises an electric motor 11, which is connected to the on-board power supply system 3 by a motor control 12. The motor control 12 is further connected to the CAN bus 4 for reception of control commands and modulates the voltage supplied to the motor from the on-board power supply system 3 by means of pulse width modulation (PWM) to allow a control of the drive power.

For control of the electric vehicle, the already mentioned central control device 9 is provided which is accordingly connected to the CAN bus 4 and for voltage supply further to the auxiliary on-board supply system 5. The control device 9 is a microprocessor control, which is being controlled by a program stored in a connected and variable memory unit 13. In this context, the control unit 9 is being used for instance for controlling the motor control 12 for driving operation according to a control command of the vehicle user entered via the operating unit 8.

The control device 9 further monitors the on-board power supply system 3 and is for this purpose connected to a measuring unit 14 which detects voltage and current on the on-board power supply system and provides according digital measuring values to the control device 9. The memory unit 13 comprises compatibility parameters in a database, which is specified in the following.

The electric system 1 of the electric vehicle 2 furthermore comprises two interfaces 15, which are formed as plug-in connectors for connection to corresponding modules 16 and which separably connect the on-board power supply system 3, the auxiliary on-board supply system 5 and the communications network 4 accordingly to the modules 16 connected to the interfaces 15. The electric system 1 of the electric vehicle 2 and in particular the on-board systems 3, 4 and 5 can certainly comprise or connect other assembly parts and components, as implied by the broken lines.

An embodiment of a module 16 provided for connection to an interface 15 is shown in a schematic view in FIG. 2. The module 16 comprises a connecting element 17 that is in the present case formed as a socket for engagement with one of the interfaces 15. The module 16 further comprises an electric arrangement, namely a 60V battery 18, which is connected to the connecting element 17 by a supply line 19 for the supply of electrical energy to the on-board power supply system 3. Alternatively, the module 16 can be formed in particular as charging column or charging device, i.e. with an appropriate power supply unit.

Interface 15 and connecting element 17 are provided as mechanically matching plug connectors. Particularly the connecting element 17 can comprise an electromotive driven bar (not shown in FIG. 2) that engages in a hook (not shown in FIG. 2) arranged in the interface 15 for locking.

A schematic view of the connecting element 17 is shown in FIG. 3. As can be understood from FIG. 3, the connecting element 17 comprises three contact elements 30 in total to connect the module 16 galvanically to the on-board power supply system 3 (+60V, −120V, GND).

The connecting element 17 comprises an integral first switch unit 20, with which the connection between the +60V supply line 19 and consequently the battery 18 with the on-board power supply system 3 can be controlled. A second switch unit 21 is provided to connect the −120V conductor of the auxiliary on-board supply system 3 switchable with module 16. As shown, this connection with the 60V-battery 18 is not used at the present battery module 16, however, in the case of a “charging module” it can be used with a suitable power supply unit for example for quick-charging of the vehicles battery 7. The ground conductor (GND) is not connected.

The switch units 20 and 21 are in the present case formed with MOSFET switches and are being controlled by a microprocessor module control 23 that is connected to the CAN bus system 4 via a wireless near-field connection. For this aim, a second NFC-unit 104 is provided on the modules site, which is in contact with a first NFC-unit 43 on the vehicles side (not shown in FIG. 3) via a near-field connection according to ISO 14443 at 13.56 MHz.

The NFC-unit 43 on the vehicle side is realized integrated with the interface 15, as explained in detail in the following. The NFC-units 43, 104 are further configured to transferring of energy, namely for connection of the auxiliary on-board power supply system 5 with the module 16 and, respectively, with an auxiliary module system (not shown in FIG. 3) on the modules side and for energy supply of the module control 23 and of an electric motor 114 (also not shown in FIG. 3) with about 20 W.

The interface 15 and the connecting element 17 therefore provide for a galvanic (conductive) connection of the module 16 with the on-board power supply system 3, while the CAN-bus system 4 and the auxiliary on-board power supply system 5 are galvanically separated from the module 16 and the module control 23.

A measuring sensor 27 is provided to detect the voltage on the supply line 19 and thus the voltage provided by the battery 18, and to provide an according measuring value to the module control 23.

Further a monitoring unit 28 is provided which monitors the maximum admissible current between module 16 and on-board power supply system 3 as well as the maximum admissible voltages, so that for example the battery 18 can be safely disconnected from the electric system 1 of the vehicle in case of a short circuit. For this purpose, the monitoring unit 28 transmits corresponding measuring values on a regular basis to the module control 23, which accordingly operates the switch units 20 and 21.

In the present embodiment, a current of 100 A between supply line 19 and on-board power supply system 3 should not be exceeded.

The monitoring unit 28, the switch units 20, 21 and the measuring sensor 27 are certainly connected to the module control 23 by suitable communications lines (not shown) and as the case may be are provided integrated therewith.

In addition, an electric motor 114 (not shown in FIG. 3) is provided that drives the previously described bar (also not shown). The electric motor 114 is being activated by the module control 23 and is being supplied with electrical energy by the NFC-device 104, as already mentioned.

An embodiment of the electric system 1 of the modular vehicle 2 with connected module 16 is shown in FIG. 4. The connection of an additional battery 18 can for instance then be necessary when the internal vehicle battery 7 is depleted or the range of the vehicle is to be increased. For this purpose, the user connects the module 16 to the interface 15, whereupon control device 9 and module control 23 communicate with each other in a compatibility mode via the CAN bus 4 and via the two NFC-devices 43, 104, to on the one hand to check the authorization for the connection of the module 16 and on the other hand to check the compatibility of the module 16 and more specific of the battery 18 of the module 16 before connecting and a locking of the battery with the on-board power supply system 3.

The method of connecting the module 16 to the interface 15 is explained in the following with reference to the embodiment according to FIG. 5, which illustrates the individual steps by means of a flowchart.

According to step 50, the connecting element 17 of the module 16 is at first being connected to one of the interfaces 15 by a user. The switch units 20 and 21 are in this state at first open, so that the battery 18 is not connected to the on-board power supply system 3. However, the connecting element 17 provides a connection of the monitoring unit 28 to the on-board power supply system 3.

As soon as the monitoring unit 28 detects a voltage on the on-board power supply system 3, the unit provides a signal to the module control 23 which in step 51 queries the measuring sensor 27 with regard to the current battery voltage on the supply line 19. Further, the module control 23 simultaneously determines multiple identification parameters from an internal memory, which characterize the module 16 with regard to model and manufacturer. In step 52, the module control 23 sends an identification signal to the control device 9 via the two NFC-devices 43, 104 and accordingly via the CAN bus system 4. The identification signal comprises the following information in the present embodiment:
Manufacturer ID: 005
Model ID: 125
Battery voltage: 49.5 V

In this context, the manufacturer ID corresponds to a particular manufacturer of the module, assigned accordingly to the ID. The model ID corresponds to the functionality “source of energy—battery”.

The control device 9 receives the identification signal in step 53 and queries the compatibility parameters of the vehicle from the database stored in the memory unit 13. In the present embodiment, the database comprises the following parameters:
Allowed manufacturers: 002-008, 057, 062, 118-255
Allowed module models: 014-042, 48, 87, 125, 144
Maximum voltage on-board power supply system (lowermost voltage level): 60.0 V
Minimum voltage on-board power supply system (lowermost voltage level):: 30.0 V

The control device 9 compares in step 54 at first the parameters comprised in the identification signal with the compatibility parameters received from the database. As follows from the preceding tables, the module 16 is generally compatible with the vehicle and eligible for connection. The control device 9 sends according to step 55 an activation signal to the module control 23, which activates the electric motor 114 of the locking bar in step 56 and locks the module 16 to the vehicle. Accordingly, the control device 9 in step 57 queries the measuring device 14 with regard to the present voltage of the on-board power supply system 3.

The query of the measuring device 14 in step 57 is necessary, as the vehicle comprises also an internal vehicle battery 7 and the voltage of the battery 18 thus should only deviate marginally from the voltage of the battery 7. In the present embodiment, the voltage on the on-board power supply system 3 is 49.5 V.

The control device 9 compares this value to the battery voltage from the identification signal in step 58 and checks if the battery voltage of the module 16 does not deviate by more than ±0.05 V from the voltage of the on-board power supply system 3.

As this is the case in the present embodiment, the control device 9 sends in step 59 a second activation signal to the switch units 20 and 21, connected to the module control 23, whereupon the supply line 19 and thus the battery 18 is connected to the on-board power supply system 3. The compatibility check and the “compatibility mode”, respectively, end in step 60.

The successful connection is indicated to the user by a green indicator lamp (see FIG. 8), such as for example a LED, which is arranged in the connecting element 17. Otherwise, a red indicator lamp (see FIG. 8) indicates in the connecting element 17 that a connection of the module 16 to the vehicle is not possible due to lack of compatibility. In this case, the electric motor 114 of the locking bar (both not shown) is being activated again to unlock module 16 from the interface 15.

During operation, the monitoring unit 28 remains active. If the predetermined maximum values for current or voltage are being exceeded, the monitoring unit 28 sends a signal to the module control 23, so that the switch unit 20 disconnects the connection between battery 18 and electric system 1 of the vehicle to avoid damages.

Certainly, the present invention is not limited to applications in which a module 16 is being connected to the vehicle 2. Also the connection of a first module, for example a charging station or charging unit, and of a second module, for example a rechargeable module with rechargeable battery, is conceivable.

FIG. 6 shows a further embodiment of a vehicle-side interface 15 together with a corresponding module-side connecting element 17. In the present embodiment module 16 is a charging module with a grid connection (not shown). The charging module comprises a power supply (also not shown), which provides multiple voltages, namely −120V DC, +60V DC on one hand for connection with the on-board power supply system 3, and +12V DC for wireless connection with the auxiliary on-board power supply system 5. The module-side 12V DC lines are in the following also referred to as “auxiliary module net” (module auxiliary power supply).

As shown, the connecting element 17 comprises three contact pins 101, 102, 103 for connection between module 16 and on-board power supply system 3, which are provided in a socket housing 100, provided as an isolator. The already in the preceding discussed NFC-unit 104 is provided hidden in the lower part of the socket housing 100, as is discussed in detail in the following with reference to FIG. 8.

As is shown in the schematic circuit diagram in the lower part of FIG. 6, contact pins 101, 102, 103 connect the module 16 with the on-board power supply system 3 of the vehicle 1 over corresponding plug-in contacts 46, 47, 48 of the vehicle-side interface 15, if plug 15 and socket 17 are connected with each other. This connection between interface 15 and connecting element 17 is electrically conductive, thus galvanic. As discussed in the preceding with reference to the embodiment of FIG. 3, the −120V DC connection is optional corresponding to the respective application. The connection of CAN bus system 4 and auxiliary on-board power supply system 5 is on the other hand wireless and thus galvanically separated from module 16. Thus, in particular contact problems are avoided with the small currents of these networks.

Corresponding to the embodiment of FIG. 3, the connecting element 17 further comprises the module control 23, the second NFC-unit 104, and the electric motor 114 of the interlock (not shown), which form an electronics unit 105. The NFC-unit 104 is controlled for communication by the module control 23. The measuring sensor 27, discussed in the preceding with reference to FIG. 3, the monitoring unit 28, as well as the switch units 20 and 21 are not shown in the FIGS. 6-8 for increased clarity, however, they could form part of the electronic unit 105. Alternatively, these components could be provided exterior of the connecting element 17 in the module 16. While the shown −120V DC, +60V DC, and +12V DC lines on the module side are connected with the power supply (not shown), discussed in the preceding, the module side CAN-low 106 and CAN-high 107 lines serve for connection of the vehicle 2 with a central data acquisition device (not shown), for billing of the charging process or for gathering diagnosis or usage information, respectively. The CAN-bus lines 106, 107 however are optional.

A partly sectional perspective view of the interface 15 with a schematic circuit diagram is shown in FIG. 7. For increased clarity, the electrical plug-in contacts 46, 47, 48 of the interface 15 are not shown in FIG. 7.

The interface 15 shown in FIG. 7 is formed as a lockable plug. It comprises a housing 33, which is shown transparent in the figure for improved clarity, in which a flexible connection means 34, for example in the form of a preferably 5 mm thick steel cable, ends. The flexible connection means 34 is affixed at a locking element 35. The locking element 35 is formed as a closed circumferential steel lug and partially protrudes from the housing 33 on a side of the interface 15, which is opposite of the side of the connection means 34, so that exterior of the housing 33, a substantially c-shaped closed lug 30 is formed, which exhibits a through opening 36 that is perpendicular to the plug direction.

Parallel to the connection means 34, the lines of the CAN bus system 4 and the auxiliary on-board power supply system 5 (conductor cross-section AWG 24, cable total 12 mm) are run. These are within the housing 33 connected with a further electronics unit 41 over a connector 46, the electronics unit 41 comprising the first NFC-unit 43 with NFC-coil 45 and a microprocessor 42 (both not shown in the lower part of FIG. 7). The microprocessor 42 herein controls the NFC-unit 43 and further eventual measuring units provided in the interface.

The NFC-coil 45 serves for wireless communication as well as the transmission of electrical energy, in particular for connecting of the auxiliary on-board power supply system 5 with the auxiliary module net, i.e., with at least the power supply of the charging module. The NFC-coil 45 is arranged, so that its coil axis is provided perpendicular to the connection direction.

The connection to the on-board power supply system 3, not shown here, can certainly also run parallel to the connection means 34.

FIG. 8 shows details of the connecting element 17, discussed in the preceding, in an exploded view together with the interface 15, as discussed in the preceding. As already discussed, the connecting element 17 comprises a housing 100, contact pins 101, 102, 103, for example in the form of 6 mm pins, the second NFC-unit 104 as well as a locking element 105.

The NFC-unit 104 is aligned in parallel to the plug direction and thus parallel to the electronics unit 41 of the interface 15, when the interface 15 is plugged in. It comprises a NFC-coil, which is not shown in the figures, and which coil axis in the mentioned case is parallel to the coil axis of the NFC-coil 45 of the interface 15 and in an optimal case corresponds to it. LEDs, arranged at the front side of the NFC-unit 104 show the current connection status, as already discussed.

The contact pins 101, 102, 103 are received in the housing 100 and contact to the corresponding plug-in contacts 46, 47, 48, if the interface 15 is plugged in. Over the contact pins 101, 102, 103 and the associated plug-in contacts 46, 47, 48, a transfer of energy to or from the on-board power supply system 3 is conducted, for example for charging the vehicle battery 7. As shown in FIG. 8, the conductors of the on-board power supply system 3 certainly have a greater cross-section, as the conductors of the CAN bus system 4 and the auxiliary on-board power supply system 5.

The locking element 105 of the connecting element 17 comprises a locking bar element 107, which is rotationally positionable using the locking motor 114. It is provided for cooperation with the locking element 35 of the interface 15 and comprises a locking cam 108, which at a corresponding radial position, interlocks with the opening 36 of lug 30, formed in the locking element 35 and locks the interface 15, plugged into the connecting element 17.

The embodiments explained beforehand allow numerous modifications and additions. For example it is conceivable that
the control unit 9 is integrally formed with the operating unit 8 and/or the motor control 12,
the switch units 20, 21 is formed on the side of the vehicle or on the side of a charging unit,
the switch units 20, 21 is integrally formed with the interface 15,
the switching units 20, 21 are arranged in the module 16,
only one or more than two interfaces 15 are arranged for connection to corresponding modules 16 in the electric system 1 of the vehicle or in a charging unit,
the internal vehicle battery 7 is separably connected to one of the interfaces 15 by means of a connecting element 17,
the CAN bus system 4 comprises optical signal lines in addition or as an alternative to the shown electric signal lines and/or wireless signal lines,
the indicator lamps and LED's, respectively, are arranged on the side of the vehicle or in a charging unit instead of at the connecting element 17,
the on-board power supply system 3 comprises only one voltage level,
interface 15 and connecting element 17 are provided with more or less than the shown three contacts 101, 102, 103 and 46, 47, 48, respectively,
the switch unit 20 is formed for separated switching of a feed line and a charging line, that are provided between module 16 and on-board power supply system 3,
the control device 9 is configured to connect the one voltage level that corresponds to the voltage of the on-board power supply system 3 (actual voltage and/or nominal voltage) with the on-board power supply system 3,
an autonomous unlocking of the locking is additionally provided, to avoid damage of the components, if a maximum safety holding force during pulling in axial direction of the plug connection is exceeded,
a predetermined breaking point is provided at the interface 15 and/or at the connecting element 17, which in case of exceeding of a given safety holding force, i.e., in a direction orthogonal to the axial direction of the plug connection, disconnects all contacts and for this reason also the vehicle 2 and the module 16 from each other,
the module (16) is designed as a passive component, i.e. for example as extension or jumper cable, and comprises besides a connecting element (17) another plug-in connector or an interface (15) for connection to another module.

The use of the term “comprising” and “comprises”, respectively, in the claims and in the present description does not exclude that there may be further features. Also, the use of the definite article does not exclude the plural. The mere specification of single features in different dependent claims or different embodiments does not indicate that a combination of these features cannot be used within the invention in a preferred embodiment. To the contrary there may be several combinations. The use of reference signs is not to be interpreted in a limiting manner.

1. Modular vehicle system, with an electric vehicle and with a module connectable with the electric vehicle via a plug-connection,
wherein the electric vehicle at least comprises:
an on-board power supply system for energy supply of an electric drive unit of the electric vehicle,
a control device for communication with the module, and
an interface connected to the on-board power supply system and with the control device for connection of the module, which interface provides a first element of the plug-connection,
wherein the module at least comprises:
an electric arrangement,
a module control for communication with the control device of the electric vehicle, and
a connecting element connected to the electric arrangement and the module control, which connecting element provides a second element of the plug-connection, wherein
the interface of the electric vehicle is separably connectable to the connecting element of the module for connecting the electric arrangement of the module with the on-board power supply system of the electric vehicle, and wherein
the interface comprises a first NFC-unit and the connecting element comprises a second NFC-unit, which are configured for near-field communication with each other, to connect the control device of the electric vehicle with the module control.

2. Modular vehicle system according to claim 1, wherein the NFC-units additionally are configured to transfer energy, in particular for electric energy supply of the control device of the electric vehicle and/or of the module control.

3. Modular vehicle system according to claim 2, wherein the electric vehicle further comprises an auxiliary on-board power supply system, the module comprises an auxiliary module net and the NFC-units are configured to transfer energy between the auxiliary on-board power supply system and the auxiliary module net.

4. Modular vehicle system according to claim 1, wherein the first NFC-unit and the second NFC-unit each comprise an NFC-coil, the coil-axes of which are orthogonal to the plug-direction and parallel to each other when the interface and the connecting element are connected as intended.

5. Modular vehicle system according to claim 4, wherein the first NFC-unit and the second NFC-unit are configured such that its coil-axes essentially completely overlap when the plug-connection is connected as intended.

6. Modular vehicle system according to claim 1, wherein a first locking element is arranged at the interface and wherein a second locking element configured for engagement with the first interlocking element is arranged at the connecting element.

7. Modular vehicle system according to claim 6, wherein an electrically operable locking drive is arranged at the first locking element and/or at the second locking element, which is configured to move at least one of locking elements between an unlocked position and a locked position.

8. Modular vehicle system according to claim 6, wherein the module control is configured to send an identification signal to the control device during connection of the connecting element with the interface, and wherein the control device is configured to receive the identification signal, to compare it with at least one comparability parameter and to send an activating signal to at least one switching unit in case of conformity, for connecting the electric arrangement with the on-board power supply system and to send an activating signal to the at least one locking drive, to interlock the connecting element with the interface.

9. Modular vehicle system according to claim 1, wherein the interface and the connecting element are configured to galvanically connect the electric arrangement of the module with the on-board power supply system of the electric vehicle at several voltage levels.

10. Modular vehicle system according to claim 1, wherein the first NFC-unit and/or the second NFC-unit comprise a NFC-control, which is configured to communicate with the control device and the module control, respectively.

11. Modular vehicle system according to claim 10, wherein the NFC-control is logically addressable.

12. Modular vehicle system according to claim 1, wherein a flexible connection means is arranged between the interface and the electric vehicle and/or between the connecting element and the module.

13. Electric vehicle connectable with a module, wherein the electric vehicle at least comprises:
an on-board power supply system for power supply of an electric drive unit of the electric vehicle,
a control device for communication with the module, and
an interface connected to the on-board power supply system for separable connection of the module, wherein
the interface comprises an NFC-unit configured for near-field communication with a further NFC-unit of the module.

14. Module for connection to an electric vehicle, wherein the module comprises:
an electric arrangement,
a module control for communication with a control device of the electric vehicle, and
a connecting element connected to the electric arrangement for separably connecting with an interface of the electric vehicle, wherein
the connecting element comprises an NFC-unit configured for near-field communication with a further NFC-unit of the electric vehicle.

15. Method for connecting an electric vehicle to a module, wherein the electric vehicle comprises an on-board power supply system for energy supply of an electric drive unit of the electric vehicle, an interface connected to the on-board power supply system for connecting with a module, and a control unit for communication with the module, and wherein the module comprises an electric arrangement for connection with the on-board power supply system of the electric vehicle, a connecting element separably connectable to the interface of the electric vehicle, and a module control for communication with a control device of the electric vehicle, wherein the interface and the connecting element are configured for near-field communication with each other, such that after connecting of the interface and the connecting element the module control and the control device of the electric vehicle wireless communicate with each other via the interface and the connecting element.
